(19) United States
(12) Patent Application Publication
(10) Pub. No.: US 2025/0029438 A1
(43) Pub. Date: Jan. 23, 2025

(54) VEHICLE INCLUDING REMOTE CONTROL KEY AND SERVER

(71) Applicants: Hyundai Motor Company, Seoul (KR); Kia Corporation, Seoul (KR)

(72) Inventors: NOOKESH NAGUMALLI, Koduru (IN); Rudra Kumar Adapa, Visakhapatnam (IN); Muzibur Rahman Shaik, Andhra Pradesh (IN); Kiran Kumar Srikakulam, Andhra Pradesh (IN)

(21) Appl. No.: 18/476,649

(22) Filed: Sep. 28, 2023

(30) Foreign Application Priority Data
Jul. 17, 2023 (IN) 202311047973

(51) Int. Cl. G07C 9/00; B60H 1/00; B60N 2/02; B60R 25/25; B62D 1/181

(52) U.S. Cl. CPC G07C 9/00309; B60H 1/00642; B60N 2/0224; B60R 25/25; B62D 1/181; G07C 9/00563; G07C 2009/00507

(57) ABSTRACT

A vehicle has a remote control key that includes a biometric sensor configured to recognize a user's bio-information, a key communication module configured to perform wireless communication with a vehicle, and at least one function button configured to control an operation of the vehicle through wireless communication with the vehicle. The vehicle also has a vehicle controller configured to compare bio-information transferred from the remote control key with bio-information stored in a server or with bio-information stored in a vehicle memory and determine whether the bio-information transferred from the remote control key is matched with the bio-information stored in the server or with the bio-information stored in the vehicle memory, the vehicle controller being configured to selectively perform a function corresponding to a control signal of the function button transmitted from the remote control key.

### CROSS-REFERENCE TO RELATED APPLICATION

This application claims priority to and the benefit of Indian Patent Application No. 202311047973 filed in the Indian Intellectual Property Office on Jul. 17, 2023, the entire contents of which are incorporated herein by reference.

### TECHNICAL FIELD

The present disclosure relates to a vehicle including a remote control key and a server, and more particularly, to a vehicle including a remote control key and a server, which are capable of preparing for a loss or theft of a remote control key.

### BACKGROUND

With the development of wireless communication technologies, various devices using wireless communication technologies have also been developed and mounted in vehicles. For example, there is a remote control key for a vehicle that remotely controls a door, a trunk, and a starter motor for a vehicle by using wireless communication.

The remote control key for a vehicle may refer to a smart key, a fob key, a remote start key, or the like. For example, the remote control key for a vehicle may refer to the smart key, the fob key, and the remote start key that use the wireless communication technologies.

The remote control key for a vehicle serves to remotely open or close a door of the vehicle. Further, the remote control key serves to remotely turn on or off a lamp of the vehicle to allow a user to recognize a position of the vehicle. In addition, when the user, who carries the remote control key, pushes a button provided on a door handle, the user may open or close the door of the vehicle. Recently, the remote control key also serves to remotely start the vehicle or remotely and automatically park the vehicle.

Various functions of the remote control key improve convenience for a user or driver. However, when the user or driver loses the remote control key or the remote control key is stolen, there is a problem in that a likelihood of a theft of the vehicle increases.

In particular, recently, the number of vehicle theft accidents caused by the loss or theft of the remote control key has rapidly increased. It has been known that most vehicle theft accidents occur because of the replication of the lost or stolen remote control key.

Therefore, there is a need for studies capable of preventing a theft of the vehicle by restricting the use of the remote control key in a case where the remote control key is lost or stolen.

### SUMMARY

The present disclosure has been made in an effort to provide a vehicle including a remote control key, which is capable of preventing a theft of the vehicle caused by replication of the lost or stolen remote control key.

The present disclosure is directed to a vehicle including a remote control key, the vehicle including: a remote control key including a biometric sensor configured to recognize a user's bio-information, a key communication module configured to perform wireless communication with a vehicle, and at least one function button configured to control an operation of the vehicle through wireless communication with the vehicle; and a vehicle controller configured to compare bio-information transferred from the remote control key with bio-information stored in a server or with bio-information stored in a vehicle memory and determine whether the bio-information transferred from the remote control key is matched with the bio-information stored in the server or with the bio-information stored in the vehicle memory, the vehicle controller being configured to selectively perform a function corresponding to a control signal of the function button transmitted from the remote control key.

When the bio-information transferred from the remote control key is matched with the bio-information stored in the vehicle memory, the vehicle controller may perform the function corresponding to the control signal of the function button of the remote control key.

When the bio-information transferred from the remote control key is not matched with the bio-information stored in the vehicle memory, the vehicle controller may determine whether the bio-information transferred from the remote control key is matched with the bio-information stored in the server.

When the bio-information transferred from the remote control key is matched with the bio-information registered in the server, the vehicle controller may perform the function corresponding to the control signal of the function button of the remote control key.

When the bio-information transferred from the remote control key is matched with the bio-information registered in the server, the vehicle controller may set a vehicle environment corresponding to the bio-information transferred from the remote control key.

The vehicle environment may include a position of a seat, a position of a steering wheel, and an interior temperature of the vehicle.

When the bio-information transferred from the remote control key is not matched with the bio-information registered in the server, the vehicle controller may not respond to the control signal of the function button transmitted from the remote control key.

The present disclosure is also directed to a server, which performs wireless communication with a remote control key, the server including: a server communication module configured to perform wireless communication with the key communication module; a server memory configured to store a plurality of pieces of bio-information matched with vehicle information; and a server controller configured to compare bio-information received through the server communication module with bio-information stored in the memory and transfer matching information to the remote control key.

In some implementations, the vehicle controller does not respond to the control signal of the function button transmitted from the remote control key in case that the bio-information recognized by the biometric sensor is not matched with the bio-information registered in the vehicle memory or the server. Therefore, it is possible to prevent the vehicle and valuables in the vehicle from being stolen even though the remote control key is lost or stolen.

### BRIEF DESCRIPTION OF THE DRAWINGS

FIG. 1 is a conceptual view illustrating a vehicle including a remote control key and a server.

FIG. 2 is a block diagram illustrating the vehicle including the remote control key and the server.

FIG. 3 is a perspective view illustrating a configuration of the remote control key.

FIG. 4 is a perspective view illustrating a configuration of the remote control key.

FIG. 5 is a flowchart for explaining an operation of the vehicle including the remote control key.

### DETAILED DESCRIPTION

Hereinafter, a vehicle 20 including a remote control key 10 will be described in detail with reference to the accompanying drawings.

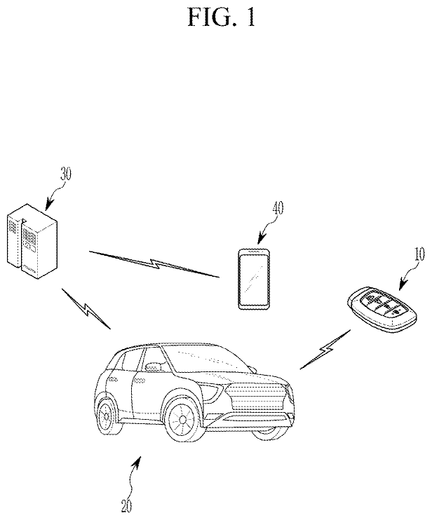

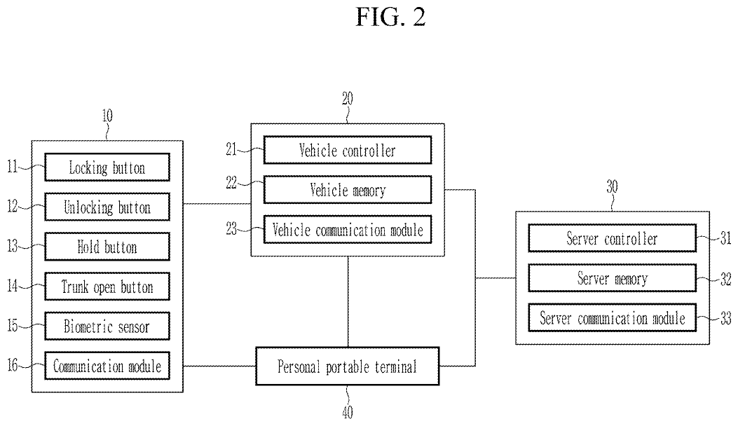

FIG. 1 is a view illustrating the vehicle 20 including the remote control key 10 and a server 30. Further, FIG. 2 is a block diagram illustrating the vehicle 20 including the remote control key 10 and the server 30.

As illustrated in FIGS. 1 and 2, the vehicle 20 including the remote control key 10 may include: a remote control key 10 including a biometric module configured to recognize a user's bio-information; and a vehicle controller 21 configured to control an operation of the vehicle 20 on the basis of the bio-information transferred from the remote control key 10.

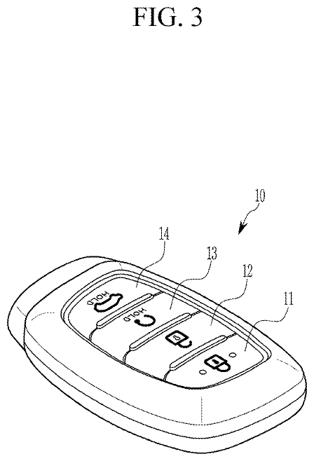

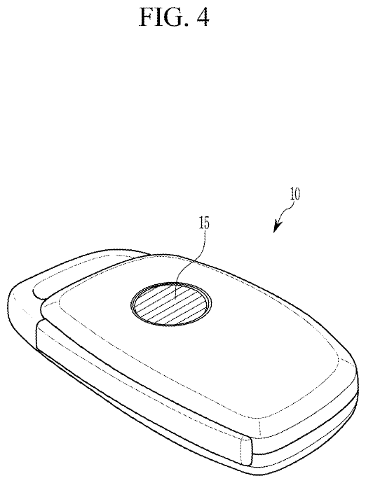

Referring to FIGS. 3 and 4, the remote control key 10 may include a plurality of function buttons, and a biometric sensor 15 configured to recognize the bio-information. The plurality of function buttons may be provided on one surface (e.g., an upper surface) of the remote control key 10, and the biometric sensor 15 may be provided on the other surface (e.g., a lower surface) of the remote control key.

The function buttons may include a locking button 11, an unlocking button 12, a hold button 13, and a trunk open button 14.

A driver (or a user), who carries the remote control key 10, may lock a door of the vehicle 20 by manipulating the locking button 11 or unlock the door of the vehicle 20 by manipulating the unlocking button 12.

In addition, the driver (or the user), who carries the remote control key 10, may lock or unlock a trunk by manipulating the trunk open button 14.

Further, the driver, who carries the remote control key 10, may open or lock the door of the vehicle 20 by pushing a door open button provided on a door handle of the vehicle 20.

The biometric sensor 15 recognizes bio-information (e.g., fingerprint information) of the driver or user, and the fingerprint information recognized by the biometric sensor 15 is transferred to the vehicle controller 21 of the vehicle 20. In some implementations, the biometric sensor 15 may be a fingerprint recognition sensor, but the protection scope of the present disclosure is not limited thereto.

To perform wireless communication with the vehicle 20, the remote control key 10 may include a key communication module 16. The key communication module 16 may perform the wireless communication with the vehicle 20 through radio frequencies or Bluetooth low energy (BLE).

The vehicle controller 21 compares the bio-information (hereinafter, as necessary, referred to as ‘the transferred bio-information’), which is transferred from the remote control key 10, with bio-information stored in a vehicle memory 22 or bio-information stored in the server 30, and then determines whether the transferred bio-information is matched with the bio-information stored in the vehicle memory 22 or the server 30.

The vehicle controller 21 may be an electronic control unit (ECU) and control an overall operation of the vehicle 20. For example, the vehicle controller 21 may be one or more microprocessors operated by a program (control logic) or hardware (e.g., a microcomputer) including the microprocessor, and the program may include a series of instructions for performing the method of controlling the vehicle 20. The instruction may be stored in the vehicle memory 22.

On the basis of whether the transferred bio-information is matched with the bio-information stored (or registered) in the vehicle memory 22 or a server memory 32 of the server 30, the vehicle controller 21 can selectively perform a function of the vehicle 20 that corresponds to a control signal of the function button transmitted from the remote control key 10. For example, the functions of the vehicle 20 may include a function of locking and/or unlocking the door, and a function of locking and/or unlocking the trunk.

When the transferred bio-information is matched with the bio-information stored in the vehicle memory 22, the vehicle controller 21 may perform the function corresponding to the control signal of the function button of the remote control key 10 and set an environment of the vehicle 20 that corresponds to the bio-information transferred from the remote control key 10. For example, the environment of the vehicle 20, which corresponds to the bio-information, may include a position of a seat, a position of a steering wheel, and a temperature in a room of the vehicle 20 provided by an air conditioner.

When the bio-information transferred from the remote control key 10 is not matched with the bio-information stored in the vehicle memory 22, the vehicle controller 21 may determine whether the transferred bio-information is matched with the bio-information registered in the server 30.

When the transferred bio-information is matched with the bio-information registered in the server 30, the vehicle controller 21 may perform the function corresponding to the control signal of the function button of the remote control key 10 and set an environment of the vehicle 20 that corresponds to the bio-information transferred from the remote control key 10.

When the transferred bio-information is not matched with the bio-information registered in the server 30, the vehicle controller 21 does not respond to the control signal of the function button transmitted from the remote control key 10.

To perform wireless communication with the vehicle 20 and the server 30, the vehicle 20 can include a vehicle communication module 23.

In some implementations, the vehicle 20 may perform the wireless communication with the server 30. In some implementations, the server 30 may include a server controller 31, the server memory 32, and a server communication module 33.

The server controller 31 stores the vehicle identification number (VIN) of the user's vehicle, which is transmitted from a personal portable terminal 40 of the user (or the driver) in the server memory 32, stores bio-information corresponding to the vehicle identification number in the server memory 32, and stores bio-information transferred from the vehicle controller 21 in the server memory 32. The server controller 31 compares the bio-information transferred from the vehicle controller 21 with the bio-information stored in the server memory 32 and transmits the comparison result to the vehicle controller 21 through the server communication module 33.

The vehicle identification number (VIN) of the vehicle 20, the bio-information corresponding to the vehicle identification number of the vehicle 20, and the environment of the vehicle 20 corresponding to the bio-information may be registered in the server memory 32 of the server 30.

Hereinafter, an operation of the vehicle 20 including the remote control key 10 will be described in detail with reference to the accompanying drawings.

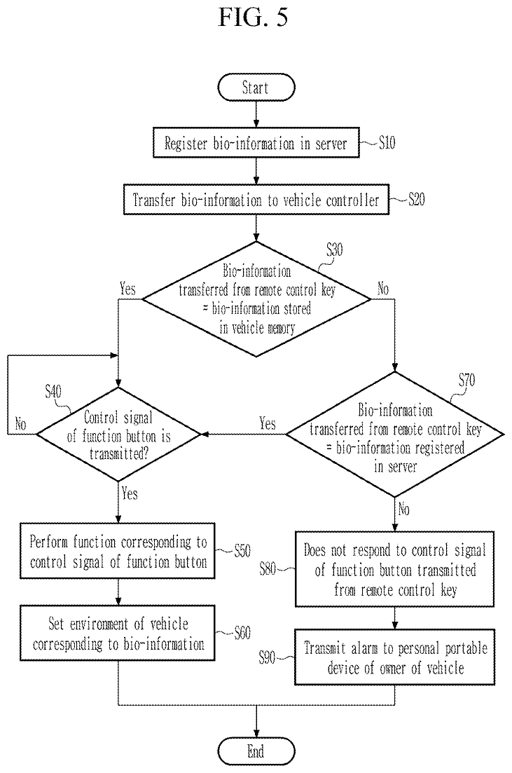

Referring to FIG. 5, the user (or the driver) registers the user's bio-information in the server 30 (S10).

For example, the user transfers the user's bio-information (e.g., fingerprint information) and the vehicle identification number of the vehicle 20 of the user to the server 30 through the personal portable terminal 40 (e.g., a smartphone, a tablet, or the like). The server controller 31 of the server 30 can register the bio-information, which corresponds to the vehicle identification number of the vehicle 20 transmitted from the personal portable terminal 40, in the server memory 32. In some implementations, the user may register a plurality of pieces of bio-information corresponding to the vehicle identification number of the vehicle 20 through the personal portable terminal 40.

When the user allows the biometric sensor 15 of the remote control key 10 to recognize the bio-information to remotely control the vehicle 20, the remote control key 10 can transfer the bio-information, which is recognized by the biometric sensor 15, to the vehicle controller 21 (S20).

The vehicle controller 21 can compare the bio-information transferred through the remote control key 10 with the bio-information stored in the vehicle memory 22 and determine whether the transferred bio-information is matched with the bio-information stored in the vehicle memory 22 (S30).

When the bio-information transferred from the remote control key 10 is matched with the bio-information stored in the vehicle memory 22, the vehicle controller 21 can be on standby until the control signal of the function button is transmitted from the remote control key 10 (S40).

When the control signal of the function button is transmitted from the remote control key 10 to the vehicle controller 21, the vehicle controller 21 can perform a function corresponding to the control signal of the function button of the remote control key 10 (S50). Because the function corresponding to the control signal of the function button may be identical to the function described above, a detailed description thereof will be omitted.

In addition, the vehicle controller 21 can set the environment of the vehicle 20 corresponding to the bio-information transferred from the remote control key 10 (S60). For example, the environment of the vehicle 20, which corresponds to the bio-information, may include the position of the seat, the position of the steering wheel, and an interior temperature of the vehicle 20.

In step S30, when the bio-information transferred from the remote control key 10 is not matched with the bio-information stored in the vehicle memory 22, the vehicle controller 21 can compare the bio-information transferred from the remote control key 10 with the bio-information registered in the server 30 and determine whether the transferred bio-information is matched with the bio-information registered in the server 30 (S70).

For example, the vehicle controller 21 transfers the transferred bio-information and the vehicle identification number of the vehicle 20 from the vehicle control key to the server 30. The server controller 31 of the server 30 can compare the bio-information, which is registered in the server 30 through the personal portable terminal 40, with the bio-information transferred from the vehicle controller 21, determine whether the bio-information transferred from the vehicle controller 21 is matched with the bio-information registered in the server memory 32 of the server 30, and transmit a result of the determination to the vehicle controller 21. Based on the result of the determination transmitted from the server 30, the vehicle controller 21 may determine whether the bio-information transmitted from the remote control key 10 is matched with the bio-information registered in the server 30.

When the bio-information transferred from the remote control key 10 is matched with the bio-information registered in the server 30, the vehicle controller 21 can be on standby until the control signal of the function button is transmitted from the remote control key 10 (S40).

When the control signal of the function button is transmitted from the remote control key 10 to the vehicle controller 21, the vehicle controller 21 can perform the function corresponding to the control signal of the function button of the remote control key 10 (S50). Because the function corresponding to the control signal of the function button may be identical to the function described above, a detailed description thereof will be omitted.

In addition, the vehicle controller 21 can set the environment of the vehicle 20 corresponding to the bio-information transferred from the remote control key 10 (S60).

In step S70, when the bio-information transferred from the remote control key 10 is not matched with the bio-information registered in the server 30, the vehicle controller 21 does not respond to the control signal of the corresponding function button even though the control signal of the function button is transmitted from the remote control key 10 (S80).

For example, the user of the vehicle 20 may have lost the remote control key 10 or the remote control key 10 may be stolen or a person, who is not authorized by the user of the remote control key 10 of the user, may be using a replicated remote control key 10. Therefore, the vehicle controller 21 does not perform the function of the vehicle 20 corresponding to the function button even though the control signal of the function button is transmitted from the remote control key 10.

For example, the vehicle controller 21 does not unlock the door of the vehicle 20 even though the control signal of the unlocking button 12, among the function buttons of the remote control key 10, is transmitted to the vehicle controller 21.

For example, the vehicle controller 21 transmits an alarm to the personal portable terminal 40 of the owner of the vehicle 20, the alarm indicating that a control signal is inputted from an abnormal remote control key (S90).

According to the vehicle 20 including the remote control key 10, the corresponding function is not performed in case that the bio-information registered in the vehicle memory 22 or the server 30 is not matched with the bio-information transferred through the remote control key 10 even though the control signal of the function button is transmitted from the remote control key 10. Therefore, it is possible to prevent a theft of the vehicle 20 or prevent important items placed in the vehicle 20 from being stolen or lost.

The terms “components,” “units,” “devices,” “blocks,” or “modules” used in the implementations of the present disclosure may be implemented in software such as a task, class, sub-routine, process, object, execution thread or program, which is performed on a certain memory area, hardware such as a field programmable gate array (FPGA) or an application specific integrated circuit (ASIC), or a combination of the software and the hardware. The components or the units may be included in computer-readable storage media or some of the components or the units may be dispersed and distributed in a plurality of computers.

What is claimed is:

1. A vehicle comprising:
a remote control key including:
a biometric sensor configured to recognize bio-information of a user,
a key communication module configured to perform wireless communication with the vehicle, and
at least one functional button configured to control an operation of the vehicle through wireless communication with the vehicle; and
a vehicle controller configured to:
compare first bio-information transferred from the remote control key with (i) second bio-information stored in a server or (ii) third bio-information stored in a vehicle memory, and
determine whether the first bio-information is identical to or different from the second bio-information or the third bio-information,
based on a determination that the first bio-information is identical to or different from the second or third bio-information, selectively perform a function corresponding to a control signal of the functional button transmitted from the remote control key.

2. The vehicle of claim 1, wherein:
the vehicle controller is configured to, based on the first bio-information being identical to the third bio-information, perform the function corresponding to the control signal of the function button of the remote control key.

3. The vehicle of claim 2, wherein:
the vehicle controller is configured to, based on the first bio-information being different from the third bio-information, determine whether the first bio-information is identical to or different from the second bio-information.

4. The vehicle of claim 3, wherein:
the vehicle controller is configured to, based on the first bio-information being identical to the second bio-information, perform the function corresponding to the control signal of the function button of the remote control key.

5. The vehicle of claim 3, wherein:
the vehicle controller is configured to, based on the first bio-information being identical to the second bio-information, set a vehicle environment parameter corresponding to the first bio-information.

6. The vehicle of claim 5, wherein:
the vehicle environment parameter comprises at least one of a position of a seat, a position of a steering wheel, or an interior temperature of the vehicle.

7. The vehicle of claim 1, wherein:
the vehicle controller is configured to, based on the first bio-information being different from the second bio-information, ignore the control signal of the function button transmitted from the remote control key.

8. A server configured to perform wireless communication with the vehicle according to claim 1,
the server comprising:
a server communication module configured to perform wireless communication with the key communication module;
a server memory configured to store a plurality of pieces of bio-information matched with vehicle information; and
a server controller configured to compare bio-information received through the server communication module with bio-information stored in the server memory and transfer matching information to the remote control key.

9. The vehicle of claim 7, wherein:
the vehicle controller is configured to, based on the first bio-information being different from the second bio-information, transmit an alarm to a device associated with the user.

10. The vehicle of claim 9, wherein:
the alarm indicates that the control signal is received from an another remote control key different from the remote control key.
